(19) United States
(12) Patent Application Publication
(10) Pub. No.: US 2015/0163581 A1
(43) Pub. Date: Jun. 11, 2015

(54) HEADPHONE WITH IN-AXLE CORD CONNECTOR

(71) Applicant: IdeaVillage Products Corp., Wayne, NJ (US)

(72) Inventor: Greg E. Blonder, Summit, NJ (US)

(21) Appl. No.: 14/566,048

(22) Filed: Dec. 10, 2014

Related U.S. Application Data
(60) Provisional application No. 61/914,001, filed on Dec. 10, 2013.

(51) Int. Cl. H04R 1/10

(52) U.S. Cl. CPC H04R 1/1033

(57) ABSTRACT

A headset including a headband having two end portions each coupled to a respective speaker housing. One or both of the end portions includes a cord connector or jack wherein an audio cord may be coupled. The cord connector is arranged on the headband in a manner such that movement a speaker housing coupled to the headband does not result in tangling of the audio cord.

### CROSS-REFERENCE TO RELATED APPLICATION

This application claims the benefit of U.S. Provisional Application No. 61/914,001, filed on Dec. 10, 2013. U.S. Provisional Application No. 61/914,001 is hereby incorporated by reference in its entirety.

### TECHNICAL FIELD

Embodiments of the present disclosure relate to the field of audio devices and, more particularly, to a headset including a cord connector or connection port arranged on a non-movable portion of a headband.

### BACKGROUND

Conventional headsets include an audio cord which extends from the headset for connection to an audio source in a manner which is inconveniently arranged. In a first exemplary conventional arrangement, as shown in FIG. 1A, the cord from the audio jack is split into a Y-shape approximately midway along its length, attaching left signal wires 101 to a left speaker enclosure 111 and right signal wires 102 to a right speaker enclosure 112 to enable each of the left and right side speakers to receive their own individual audio signals. The two arms of the cable are permanently attached to each enclosure, typically through a rubber strain-relief near the bottom of each speaker.

In another conventional arrangement shown in FIG. 1B, a cable 120 carrying the left and right signals (and common ground) is attached to a left speaker housing 121, typically via a rubber strain-relief near the bottom of the speaker enclosure. The cable is then split into a left and right signal within the speaker housing, and the right signal and ground signal are routed through a head band to the right speaker.

In certain instances, the attachment of a single audio cable is removable, most commonly by replacing the rubber strain relief by an audio jack, and the permanent audio cable by a double-ended cable, with a male audio plug on both ends. This allows the user to switch cable lengths, or choose a cable with an integrated microphone.

However, the above-described arrangements are inconvenient and inappropriate for a headset wherein the connection juncture between the cord and the housing is movable, such as a headset capable of converting between a speaker configuration and a headset configuration by twisting each speaker housing around an axle by up to 180 degrees. For example, U.S. patent application Ser. No. 13/815,538, filed on Mar. 8, 2013, and U.S. patent application Ser. No. 14/053,799, filed on Oct. 15, 2013, the entirety of both are hereby incorporated by reference herein, disclose a headset including an amplifier within at least one speaker housing which is activated by twisting or turning the speaker housing into a particular position.

In such multi-mode headsets, a cord attached to the bottom edge of the left speaker is forced to rotate in tandem with the speaker housing (such wide degrees of rotation are less common in conventional headsets). This motion causes the cord to twist or tangle. It also permits a tug on the cord to twist the speaker enclosure out of position.

Furthermore, for conventional arrangements wherein the cord is hardwired in a fixed position and extends from one of the speaker housings (e.g. a left speaker enclosure, as shown in FIG. 1B), a left-handed user may prefer attachment of the audio cord to a right speaker. Similarly, a right-handed user may prefer to clip or otherwise attach or arrange the audio source on a right side of his or her body (e.g., in a right pocket), thereby forcing the audio cable to cross his or her chest to the left speaker. The crossing of the audio cord across the user's body may interfere with the operation of a zipper of the user's garment (e.g., a jacket).

### BRIEF DESCRIPTION OF THE DRAWINGS

The accompanying drawings are included to provide a further understanding of the present disclosure. These drawings are incorporated in and constitute a part of this specification, illustrate one or more embodiments of the present disclosure and together with the description, serve to explain the principles of the present disclosure.

FIG. 1A illustrates a front view of headset including a Y-shaped split audio cord;

FIG. 1B illustrates a front view of a headset including an audio cord fixedly attached to a left speaker housing.

FIG. 2 illustrates a perspective exploded view of a headset including a removable audio cord pluggable into a portion of a headband, according to implementations of the present disclosure;

FIGS. 3A-3C illustrates perspective views of a headset including a removable audio cord pluggable into a portion of a headband coupled to a movable speaker housing, according to implementations of the present disclosure.

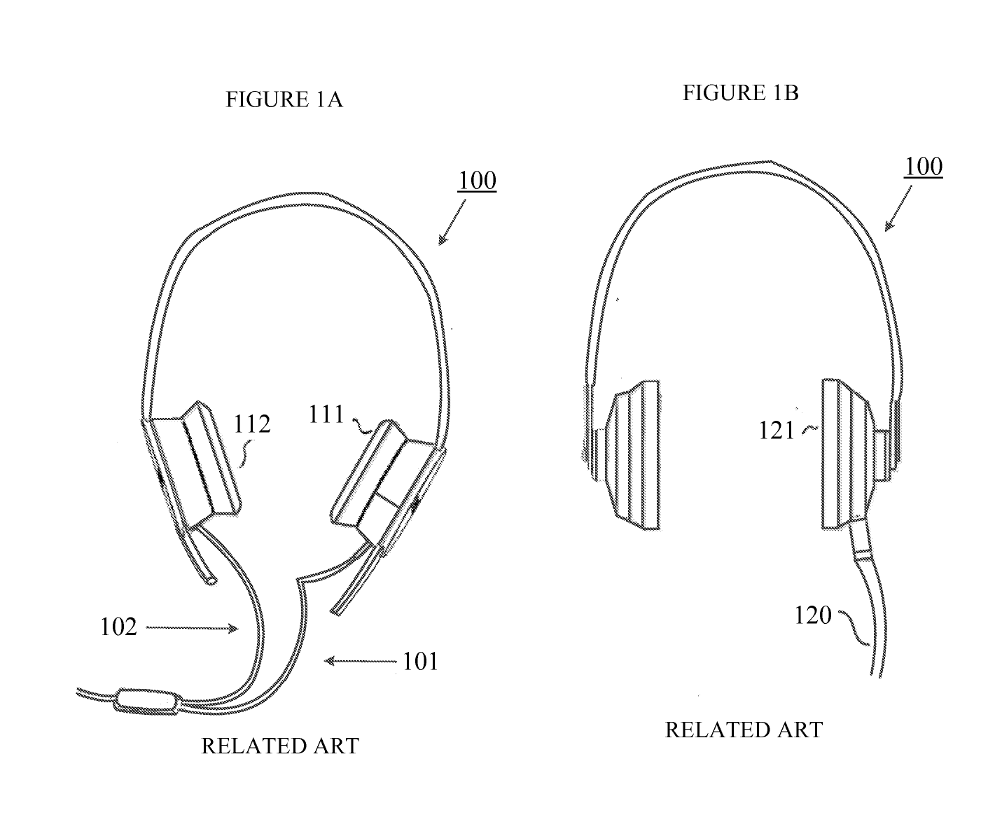

### DETAILED DESCRIPTION

The present disclosure relates to a headset including a connection port arranged on a non-moving portion of a headband portion. In an implementation, the headset is a convertible headset capable of converting from a wearable headset to a speaker. In an implementation, the headset includes an amplifier within at least one speaker housing which is activated by twisting or turning the speaker housing into a particular position (e.g., the extendable headset may be placed in “speaker mode” by twisting the headphone enclosures away from the ears to convert the headset into an externally-directed amplified speaker). U.S. patent application Ser. No. 13/815,538, filed on Mar. 8, 2013, and U.S. patent application Ser. No. 14/053,799, filed on Oct. 15, 2013, the entirety of both are hereby incorporated by reference herein, disclose an exemplary convertible headset, according to embodiments of the present disclosure.

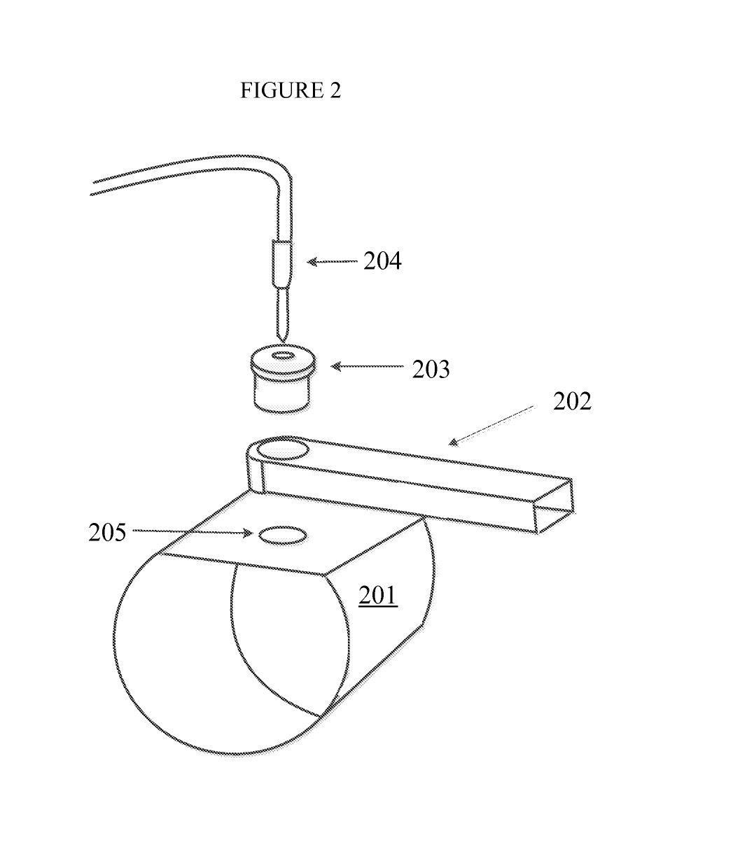

In an implementation, the headset includes a connection port configured to connect with an audio cord for connection with an audio source cord or cable (e.g., audio cord 204 in FIG. 2) which is connectable to an audio source (e.g., a mobile device, an MP3 player, a tablet, any suitable computing device, etc.). In an implementation, the connection port is arranged on a non-movable or fixed portion of the headset such that the audio cord remains unaffected when the speaker enclosures are twisted (e.g., to enable transition between a speaker and headset mode). In an implementation, each side of the headband (e.g., a right side connected to a right speaker housing and a left side connected to a left speaker housing) may include the jack for receiving the plug of the audio cord, to allow a user to switch the side of the headset to which the audio cord is connected.

In an exemplary implementation, shown in FIG. 2, the connection port comprises jack 203 is arranged collinearly with a rotary joint of a portion of a headband 202 around which the speaker enclosure or housing 201 rotates. In an implementation, a first end portion of the headband 202 couples to a movable speaker housing 201 via an axle. The jack 203 is configured to couple with the audio cord 204. As shown in the exploded view of FIG. 2, the speaker housing 201 is movably coupled to headband 202 by a rotary axle. In an implementation, jack 203 also functions as a rotary axle, rigidly connected to speaker housing 201. In an implementation, jack 203 may be mounted into headband 202 (a portion of which is illustrated in FIG. 2) in such a manner to enable the jack 203 and/or the audio cord 204 to rotate within a portion of headband 202. In an implementation, jack 203 is configured to fit within an opening of the end portion of the headband 202 (e.g., circular opening shown in FIG. 2). In another implementation, jack 203 may be shaped and sized to fit within the corresponding opening of the headband 202 in a manner such that jack 203 rotates freely within the opening and attaches or couples the headband 202 to the speaker housing 201 via the axle. In an implementation, the axle may be formed by the coupling of a portion of the headband 202, the speaker housing 201, jack 203, audio cord 204, or any combination thereof. In an implementation, the speaker housing 201 may include an opening 205 configured to receive a portion of headband 202, jack 203, and/or audio cord 204. In an implementation, the audio cord 204 may be inserted and removed from jack 203 by a user.

According to implementations of the present disclosure, jack 203 is a component adapted to couple with the plug 204 and includes at least a portion configured to fit within the sleeve 205 portion of the speaker housing 201. In an implementation, the plug 204 rotates inside jack 203, thus preventing tangling of the associated cord upon movement of the speaker, such as speaker rotation. In an implementation, the plug 204 rotates with jack 203 inside of opening 205 to avoid tangling of the associated cord upon movement of the speaker. In an implementation, the electrical coupling or contacts may be maintained during rotation by any suitable mechanism, such as, for example, via spring fingers arranged inside jack 203 acting as slip rings, by twisting a cable between jack 203 and a component within the speaker housing (e.g., an amplifier), or by one or more slip rings arranged on the outside of jack 203. According to implementations of the present disclosure, jack 203 may be contained within headband 202, in the axle, in the speaker housing 201, or any combination thereof.

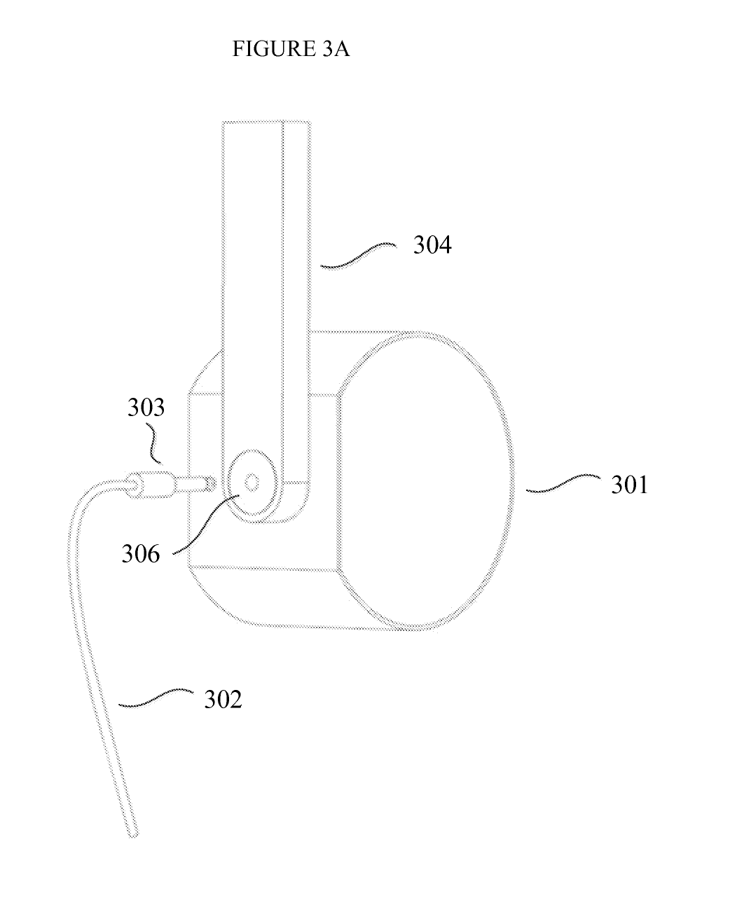

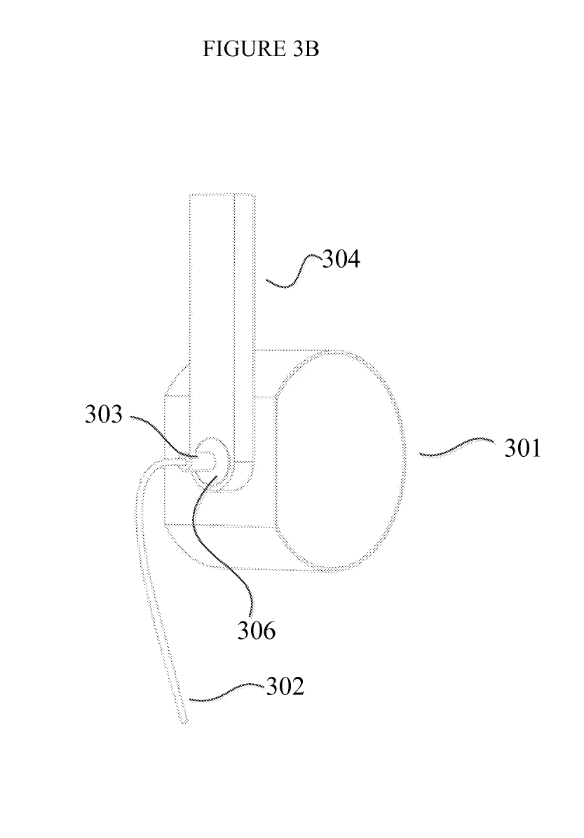

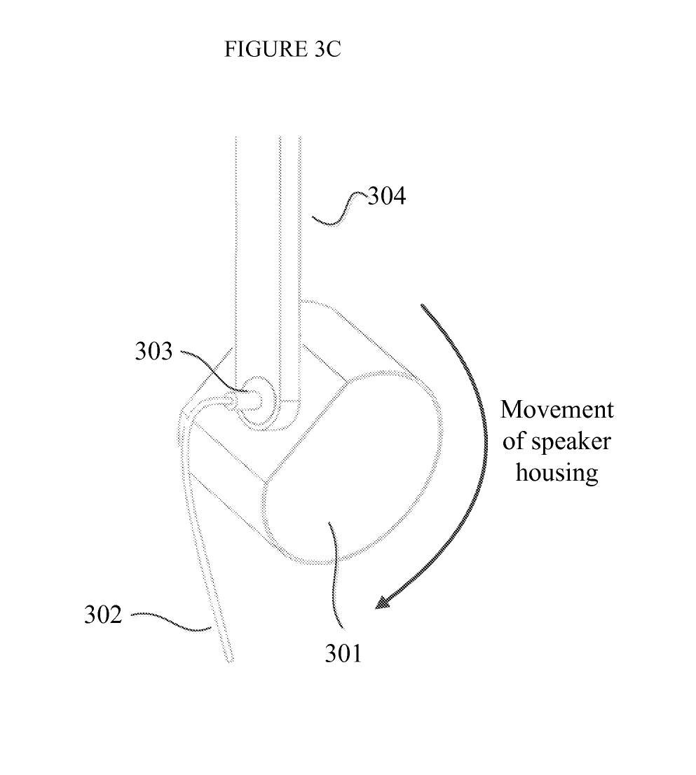

FIG. 3A-3C illustrate another exemplary implementation of a headset according to the present disclosure. As shown in FIG. 3A, speaker housing 301 is configured to rotate around an end of headband 304. A plug tip portion of an audio plug 303 of an audio cable 302 is shown prior to insertion into jack 306 arranged in an axle of the headband 304. In an implementation, since jack 306 is fixed to a portion of the headband 304, when audio plug 303 is inserted, the audio plug 303 does not rotate with speaker housing 301 (e.g., during transition of the speaker between a headset mode and a speaker mode). As shown in FIG. 3B, the audio plug portion 303 coupled to audio cord 302 may be inserted into jack 306. In an implementation, the wires connected from jack 306 (the wires of jack 306 are not shown) to one or more internal electrical connections of the headset may move, rotate, or twist as the speaker enclosure 301 moves or rotates, as shown in FIG. 3C.

According to another implementation, the audio cord 302 without a jack may be employed which is fixed to the position occupied by jack 306, such that one or more wires of the audio cord 302 connect to one or more internal electrical connections comprised within the speaker housing 301 such that the wires of the audio cord 302 do not rotate with the movement or rotation of the speaker housing 301 (e.g., the directional arrow illustrating an exemplary movement of the speaker housing 301 in FIG. 3C). In an example wherein the wires of the audio cord 302 connect with the electrical connections within the speaker housing 301, jack 306 may be replaced by a rubber strain-relief.

Advantageously, a headset including a connection port or jack arranged on a non-movable or fixed portion of a headband provides a great convenience to the user. In an implementation, the headset may be configured to include a connection jack on both ends of the headband, neither of which are attached to the rotatable speaker housings. In an implementation, the one or more connection jacks are located in a center of each rotary joint, as shown, for example, in FIGS. 2 and 3.

In an embodiment, the audio plug (e.g., audio plug 204 in FIG. 2 or audio plug 303 in FIGS. 3A-3C) may be molded or otherwise configured with an angled bend (e.g., a right angle bend) such that the audio cord does not point directly away from the speaker housing.

In addition to embodiments wherein the audio device is configured for dual mode operation(e.g., a device configured to transition from a first headset configuration (wearable by a user) to a second speaker configuration), the audio device may also be configured to include a speaker portion which is movable while operating in a single mode. In this regard, any audio device having a movable speaker housing portion may include a jack (e.g., jack 203 of FIG. 2 or jack 306 of FIG. 3) arranged on a non-movable or fixed portion of a headband (e.g., headband

As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

It is to be understood that the above description is intended to be illustrative, and not restrictive. Many other embodiments will be apparent to those of skill in the art upon reading and understanding the above description.

What is claimed is:

1. An apparatus comprising:
a movable speaker housing;
a headband comprising a first end portion, wherein the first end portion of the headband and the movable speaker housing couple via an axle; and
a jack portion rotably coupled within the axle, wherein the jack portion is configured to receive a plug comprising an audio cord, and wherein the jack portion rotates within the axle upon movement of the speaker housing.

2. The apparatus of claim 1, wherein the plug and the audio cord rotate with the jack portion within the axle upon movement of the speaker housing.

3. The apparatus of claim 2, wherein rotation of the plug and the audio cord with the jack portion prevents tangling of the audio cord upon movement of the speaker housing.

4. The apparatus of claim 1, wherein the headband comprising a first opening configured to receive the jack portion.

5. The apparatus of claim 4, wherein the coupling of the jack portion, the first opening, and the speaker housing forms a rotary joint.

6. The apparatus of claim 5, wherein the speaker housing rotates around the rotary joint.

7. An apparatus comprising:
a movable left speaker housing;
a movable right speaker housing;
a headband comprising a first end portion and a second end portion, wherein the first end portion couples to the movable left speaker housing to form a left axle, and wherein the second end portion couples to the movable right speaker housing to form a right axle, the headband;
a first jack portion rotably coupled within the left axle; and
a second jack portion rotably coupled within the right axle,
wherein the first jack portion and the second jack portion are each configured to receive a plug comprising an audio cord.

8. The apparatus of claim 7, wherein coupling of the first jack portion, the left axle, and the movable left speaker housing forms a first rotary joint.

9. The apparatus of claim 8, wherein the plug and the audio cord are configured to rotate within the first rotary joint upon insertion of the plug into the first jack portion.

10. The apparatus of claim 7, wherein coupling of the second jack portion, the right axle, and the movable right speaker forms a second rotary joint.

11. The apparatus of claim 10, wherein the plug and the audio cord are configured to rotate within the second rotary joint upon insertion of the plug into the second jack portion.

12. The apparatus of claim 7 wherein rotation of each of the movable left speaker housing and the movable right speaker housing about a respective axis of rotation transitions the apparatus between a first listening mode and a second listening mode.

13. The apparatus of claim 12, wherein the headband is configured for positioning on a user's head such that an audio output element of each of the movable left speaker housing and the movable right speaker housing substantially face toward the user's ears during the first listening mode.

14. The apparatus of claim 12, wherein the movable left speaker housing and the movable right speaker housing are configured for positioning such that the movable left speaker housing and the movable right speaker housing substantially face away from one another when the apparatus is transitioned into the second listening mode.

15. An apparatus comprising:
a speaker housing containing one or more electrical connections;
a connection port; and
a headband comprising a first end portion configured to couple to the speaker housing via an axle, wherein one or more wires of the connection port pass through the axle to electrically couple with the one or more electrical connections in the speaker housing, and wherein the one or more wires of the connection port twist in response to movement of the speaker housing.

16. The apparatus of claim 15, wherein the connection port further comprises a jack within the axle.

17. The apparatus of claim 16, wherein the jack is fixed within the axle.

18. The apparatus of claim 17, wherein the jack comprises one or more wires configured to electrically couple to the one or more electrical connections of the speaker housing.

19. The apparatus of claim 18, wherein the one or more wires of the jack rotate in response movement of the speaker housing.

20. The apparatus of claim 15, wherein the connection port comprises an audio cord.
